(19) United States
(12) Patent Application Publication
(10) Pub. No.: US 2006/0158055 A1
(43) Pub. Date: Jul. 20, 2006

(54) Tangential induction dynamoelectric machines

(76) Inventor: Gennadii Ivtsenkov, Hamilton (CA)

Correspondence Address: GENNADII IVTSENDOV, 386 REXFORD DRIVE, HAMILTON, ON, L8W3Y7, CA

(21) Appl. No.: 11/162,916

(22) Filed: Sep. 28, 2005

Related U.S. Application Data
(60) Provisional application No. 60/593,445, filed on Jan. 14, 2005.

(51) Int. Cl. H02K 21/12

(52) U.S. Cl. 310/156.01

(57) ABSTRACT

Novel class dynamoelectric machines utilizing “tangential induction” phenomenon—the specific e.m.f. induction, which appears in tangential conductors—is introduced. Alternating-current dynamoelectric machines of this invention house an axially-polarized multi-polar permanent magnet rotor and stator winding having tangentially arranged semi-ring conductors. The rotating permanent-magnet rotor induces current in tangential semi-ring conductors, which, according to Ampere law, could not produce a resistance moment applied to the rotor because the vector of conductor-field velocity is directed along the conductor, and, therefore, such vector orientation does not produce any tangential force. The invention has been successfully embodied in number of “tangential-induction dynamoelectric machines” including multi-phase ones. These dynamoelectric machines can be inverted and work as alternating-current asynchronic electric motors.

### FIELD OF THE INVENTION

The present invention relates to the dynamoelectric and electric rotating machines, such as electric generators and motors utilizing a permanent magnet rotor. More particularly, the invention pertains to utilize the phenomenon of “tangential induction” in dynamoelectric machines. The present invention also relates to homopolar electric generators.

### BACKGROUND OF THE INVENTION

This application is the corresponding non-provisional one related to the provisional application No. 60/593,445 filed Jan. 14, 2005.

Dynamoelectric machines with permanent-magnet rotor are used for many applications. Such machines, for example, the generators described in U.S. Pat. No. 3,237,034 issued to S. Krasnow Feb. 22, 1966, U.S. Pat. No. 3,334,254 issued to Kober et al. Aug. 1, 1967 and U.S. Pat. No. 5,767,601 issued to Uchiyama Jun. 16, 1998, usually utilize a radial-polarized multi-pole permanent magnet and a number of solenoid windings axially oriented on the radius, which have specially configured core made of permalloy or ferrite. These machines develops electromotive force (e.m.f.) in accordance with Faraday's law—“any change in the magnetic environment of a coil of wire will cause a voltage (e.m.f.) to be “induced” in the coil”. Faraday's law is described by formula:
E=−Ndφ/dt, [1]
Where:
φ—magnetic flux (BxA),
N—number of turns of the coil,
A—area of coil,
B—field strength.

Here, φ=ΣBΔs—is an integral value of total magnetic flux running through the coil. It is not applicable to a single conductor, and it does not describe deposit of each element of the contour in e.m.f. induction.

Faraday's mechanism of e.m.f. induction is completely static one, where e.m.f. depends on time variation of magnetic field only. Also, Faraday's law does not deal with relative movement of a coil against magnetic field.

There is another mechanism of e.m.f. induction—motional e.m.f. induction based on Lorentz law. I this case, a motion of a conductor across magnetic field separate charges, so inducing e.m.f. in the conductor. E.m.f. induced in such way can be described by formula:
dE=V.B dL, [2]
Where:
V—velocity of conductor movement across the field,
B—strength of the field,
L—length of the conductor.

Very often, this mechanism is confused with Faraday's one and described as “right hand law”. In this case, e.m.f. induction is artificially explained as expansion of close contour when one conductor of a square contour is rolling on side conductors. According to such approach, area of the contour is being enlarged and, therefore, total flux increases. Historically, this definition had been introduced before Lorentz's force phenomenon was discovered. The formula of induced e.m.f. derived by such way is completely similar to mentioned above formula [2], but this formula [2] is based on real physical phenomenon. So, it is obvious that formula [2] is based on Lorentz's phenomenon, not on Faraday's one. The motional (Lorentz's) e.m.f. induction is applicable to a single element of conductor, unlike integral Faraday's formula, but deals with relative motion of conductor and field only. Here, total e.m.f. induced in a contour is a sum of e.m.f induced in all part of the contour. And—it is important—this mechanism does not induce any e.m.f. when static magnetic field is changed in time.

Therefore, despite of possibility of the single basic principal of induction (that has not been discovered yet), there are two distinctive mechanisms that induce e.m.f. in a conductor: static Faraday's and dynamic Lorentz's ones. Motional induction (Lorentz's) formula describes a single conductor as well as a close circuit, unlike Faraday's formula describing close circuit only. Even though it is understandable, that all elements of close contour provides its own deposit in total e.m.f. generated by Faraday's mechanism, the formula for the e.m.f. induced in such element does not exist. Also, a number of experiments, particularly, Francisco Muller's ones (Muller F. in Progress in Space-Time Physics 1987, ed. J. P. Wesley, Benjamin Wesley Publisher, 78176 Blumberg, Germany, pp. 156-167) reveal that induction occurs locally and that the force of induction does not have to involve an entire closed current loop.

Moreover, there are a number of paradoxes in theoretical and practical electromagnetism. In the result, there are a number of electrical machines that have not to work according to conventional electromagnetic laws, such as statorless homopolar generator, Marinov Motor, etc.

The homopolar generators, such as one described in U.S. Pat. No. 1,922,028 issued to Chaudeysson Aug. 15, 1933, are successfully used now to provide very high current at low voltage. Numerous experiments with homopolar generators reveal unexplained feature of the generator: e.m.f. is induced only when the conductive disk rotates, and it is not induced when the magnet is rotating against the disk. Moreover, the same e.m.f. is induced in the case when the disk is firmly mounted on the magnet and rotating together with the magnet—no relative movement at all (FIG. 1).

Such generator depicted in FIG. 1 contains the rotor only, where the induced e.m.f. is tapped off by two brushes positioned on the axis and a peripheral point (edge) of the disk. Because, in the case of homopolar generator, the e.m.f. is produced by motional (Lorentz's) induction only, such phenomenon shows that movement of magnetic body could not mean that the associated magnetic field also moves.

The present invention is based on the series of experiments, which was conducted by the author of this invention (G. Ivtsenkov) to determine conditions causing e.m.f induction in conductors with different shape and position against rotating permanent magnet. In the result, the paradox of “tangential induction” was discovered and researched, and the dynamoelectric machines utilizing this effect were invented.

### OBJECT OF THE INVENTION

It is an object of the present invention to provide a dynamoelectric machines with permanent-magnet rotor that utilize “tangential induction” phenomenon.

### SUMMARY OF THE INVENTION

The present invention introduces the novel class of dynamoelectric machines utilizing “tangential induction”—specific e.m.f. induction, which appears in tangential conductors and, according to conventional electromagnetic laws, does not produce any tangential forces. Therefore, theoretically, the rotor does not transmit any rotating moment to stator. The present invention is based on the series of experiments, which was conducted by the author of the present invention. In these experiments, an axially-polarized permanent ferrite magnet (70×30×10-mm ring, Br=0.274 TI) having two opposite-polarized 180-degree sections (FIG. 2a) was used as a rotor. In the case of axially-polarized magnet ring, N and S poles appear as two circumferences on top and bottom sides of the magnet (FIG. 2b). In the case of two opposite-polarized sections, the poles appear as arcs on the top and bottom of the magnet (FIG. 2a).

In the experiments, the rotor was surrounded by not-moving semi-ring conductors (FIG. 3A). The gap between the semi-ring and rotor surface was minimized up to value preventing mechanical contact between the rotor and semi-ring.

The e.m.f. inducted in this conductor has distinctive sinusoidal shape with amplitude of ±8 mV and frequency of 17 Hz at 1000 rpm (graph U34 on FIG. 3D).

When the tangential part of the semi-ring was gradually diminished to arc with small angle, the ems shape becomes distorted and transformed into series of opposite peaks. The experiment, also, shows that the maximal amplitude in the cases of sinusoidal and pulse signal reaches the maximum when the radius dividing the magnet onto two opposite-polarized parts passes the middle of the semi-ring or arc. Therefore, it is a real fact that e.m.f is induced in a tangential conductor (ring, semi-ring, arc) when the vector of linear magnet-conductor velocity is directed along the conductor. According to the conventional electromagnetic laws, motional (Lorentz's) e.m.f. can not be induced in this case. This phenomenon was named by the author of this invention as “a tangential induction”. Additionally, a radial not-moving conductor was placed near the top of the rotating permanent magnet rotor (FIG. 3A).

The e.m.f. inducted in this conductor has distinctive trapezoidal shape with amplitude of ±4 mV and frequency of 17 Hz at 1000 rpm (graph U12 on FIG. 3D).

Also, the experiments reveal that phases of both signals, induced in the semi-ring and radial conductor, are shifted on 180 degrees against each other. It shows possibility to create a multi-turn stator coil, which can be implemented in dynamoelectric machines based on the mentioned above effect of tangential induction.

Additionally, the rotor was completely surrounded by stationary conductive ring. In this case, the same e.m.f. was indicated between two diametrical opposite points of the ring (FIG. 3B). Moreover, in another experiment the ring was firmly mounted on the rotor and rotates with the rotor. In this case, the same e.m.f., again, was indicated between two diametrical opposite points of the ring. Here, e.m.f. was tapped off by brushes positioned on diametrical opposite points of this ring.

Analysis of these experiments reveals some possible mechanisms of e.m.f. induction in the stator of such dynamoelectric machine:

The e.m.f. induced in the ring, semi-ring or arc can not be produced by motional (Lorentz's) mechanism. It could be induced by Faraday's mechanism only, but analysis of flux variation, especially for complete ring surrounding the rotor, shows that there is no variation of the total flux in this contour.

The e.m.f. induced in the straight conductor that is placed in the rotational plane of the rotor could be induced by motional (Lorentz's) mechanism or Faraday's one, or both mechanisms are involved in.

According to conventional electromagnetic laws, no tangential forces are produced in the ring stator; there are radial forces only that can not produce any resistance moment. Therefore, if the conventional laws are right, such dynamoelectric machine develops e.m.f. in tangential conductors and current running in these conductors (when stator of this machine is loaded) does not produce any resistance moment.

To explain e.m.f. induction in the case of the ring conductor, the author of the present invention introduced the modified Lentz's principle.

All magnetic sources including conductors and permanent magnets produce a magnetic field (vector B) circulation. In the case of conductor with running current, the circulation axis is matched with the conductor axis. Experiments conducted by the author reveal that an axially polarized ring magnet has two circulation axes—external and internal ones—producing opposite circulation, wherein N and S poles appear on the surface dividing two opposite circulations (FIG. 2b). In the case of the disc or sphere, which do not have any internal openings the internal circulation axis collapses into point.

Thus, the modified Lentz's principle can be formulated as follows:

“When a magnetic field (vector B) circulation is changed, it induces a current in a placed here conductor, which produces magnetic field circulation that tries to compensate the circulation change”.

This principle can be applicable to a single conductor as well as to an element of close contour.

In the case of the semi-ring (ring) conductor, when the semi-ring passes the plane dividing the magnet on two parts with opposite polarization, the circulation gradually declines, change direction and gradually increases. The tangential (ring, semi-ring or arc) conductor is responding by induction of the current that produce the circulation compensating this initial circulation variation. Thus, “the tangential e.m.f.” is developed. This principle was successfully used by the author to design the dynamoelectric machines—the object of the present invention.

The present invention introduces the dynamoelectric machines based on the experimental and theoretical researches mentioned above. These machines comprise:
a rotor containing an axially-polarized permanent-magnet ring with two or more opposite polarized sections,
a stator having stationary multi-turn winding that consists of a number of semi-ring conductors and conductors connecting ends of the semi-rings in such a way that e.m.f. induced in said semi-rings add together.

Moreover, additional experiments with these dynamoelectric machines reveal the possibility of its inversion and utilization as alternating-current asynchronic electric motors.

### DETAILED DESCRIPTION OF THE PREFERRED EMBODIMENTS OF THE INVENTION

The scheme of the invention is shown in FIG. 4.

The tangential-induction alternating-current dynamoelectric machine—the preferable embodiment of the present invention—contains a permanent-magnet rotor 100 and a specially-organized multi-turn stator winding 200. The rotor 100 consist of a combined permanent-magnet ring containing two axially-polarized semi-ring parts 101 and 102 with opposite polarization. The rotor 100 rotates around axis 103 that is aligned with axis of symmetry of the magnet.

The stator 200 consists of multi-turn coil containing tangential semi-ring conductors (members) 202, radial conductors 203, short vertical conductors 204 and two terminals 205 and 206. The tangential conductors 202 are positioned on a plane crossing the middle of cylindrical surface of the magnet, where, according to the experiments, induced tangential e.m.f. is the maximal. The radial conductors 203 connect the opposite ends of the tangential conductors 202 in such a way that e.m.f. induced in tangential conductors (semi-rings) 202 adds to e.m.f. induced in radial conductors 203. The vertical conductors 204 connect the tangential conductors (semi-rings) 202 to radial conductors 203. The terminals 205 and 206 are connected to the ends of the coil 201.

When the machine is loaded, a current running in the tangential conductors 202, according to Ampere law, do not produce any tangential forces, just radial ones. Thus, theoretically, the tangential conductors providing the main part of e.m.f. developed by this dynamoelectric machine do not produce any resistance moment.

The prototype of this dynamoelectric machine was developed and tested. The design of the prototype is shown on FIG. 5.

Here, the rotor contains an axially-polarized 70×30×10-mm ring permanent magnet with Br=0.274 TI. The magnet consists of two semi-ring parts with opposite polarization. The stator coil consists of tangential, radial and vertical members connected in multi-turn winding according to the diagram shown on FIG. 4. This 90-mm diameter coil contains 460 semi-loops (tangential members) and develops 2VAC, 17 Hz at 1000 rpm. This prototype had relatively high technological air gap between the rotor and stator (10 mm) that significantly declined the e.m.f. developed by this machine. The voltage and frequency produced be this generator is directly proportional to rotational speed of the rotor. Calculations shows that possible e.m.f. of this dynamoelectric machine can reach 40VAC, 34 HZ at 2,000 rpm, if the rotor is made of NdFeB magnet and the air gap is minimized to 2 mm. A permalloy screen cylindrically surrounding the stator, also, can twice increase the e.m.f.

Alternating-Current Dynamoelectric Machine with Combined Dual Permanent-Magnet Rotor and Two-Stage Multi-Turn Winding Stator

This alternating-current dynamoelectric machine utilizes the mentioned above phenomenon of tangential induction. The embodiment is depicted in FIG. 6.

In this embodiment, a combined dual permanent-magnet rotor was introduced that allows eliminating the radial members 203 (FIG. 4) of the previous embodiment.

A dynamoelectric machine of this embodiment contains a dual permanent-magnet rotor 100 and a stator 200. The rotor 100 consists of two similar vertically-spaced permanent-magnet rings 104 and 105, wherein each magnet ring (similar to one of the previous embodiment) consists of two axially-polarized semi-ring parts with opposite polarization. The rings 104 and 105 are turned against each other in such a way that polarization of the semi-rings are opposite, and the rings repel each other. The rotor 100 rotates around axis 103 that is aligned with axis of symmetry of the magnets. The stator consists of multi-turn winding, which contains two sets of tangential semi-ring conductors 211 and 212, vertical conductors 213 and two terminals 218 and 219. In this embodiment the tangential semi-ring conductors 211 are positioned on a plane crossing the middle of cylindrical surface of the magnet ring 104, and the tangential semi-ring conductors 212 are positioned on a plane crossing the middle of cylindrical surface of the magnet ring 105 in such a way that the position of the semi-loop conductors 212 is shifted on 180 arc degrees against the position of the conductors 211 (as depicted in FIG. 6). Because of this, e.m.f. induced in the semi-rings 212 is in opposite polarity to e.m.f. induced in the semi-rings 211. The vertical conductors 213 connect the semi-ring conductors in such a way that e.m.f. induced in the conductors 211 and 212 add together so providing multi-turn winding.

The prototype of this dynamoelectric machine was developed and tested. Here, the rotor contains two axially-polarized 70×30×10-mm permanent-magnet ring with Br=0.274 TI, wherein each magnet ring consists of two semi-ring parts with opposite polarization. The axial air gap between the rings was 5 mm. The stator coil consists of tangential and vertical members connected in multi-turn winding as is depicted in FIG. 6. This 90-mm diameter coil contains 9 semi-rings (tangential members) and develops ±25 mV, 17 Hz at 1000 rpm. This prototype has relatively high technological air gap between the rotor and stator (10 mm) that significantly declines the e.m.f. developed by this machine. The voltage and frequency produced be this generator is directly proportional to rotational speed of the rotor. Direct measurements of e.m.f. induced in the conductors 211, 212 and 213 of the stator winding show that the main part of e.m.f. is induced in the tangential semi-ring conductors 211 and 212 (about ±2.8 mV/semi-ring), whereas the member 213 provides less than 0.5 mV/vertical member.

When the machine is loaded, according to Ampere law a current running in the tangential members 211 and 212 does not produce any tangential forces, just radial ones. Thus, theoretically, the tangential members providing the main part of e.m.f. developed by this dynamoelectric machine do not produce any resistance moment.

Alternating-Current Dynamoelectric Machine with Combined Dual Permanent-Magnet Rotor and Inclined-Plane Multi-Turn Winding Stator

This dynamoelectric machine utilizes the mentioned above phenomenon of tangential induction. The embodiment is depicted in FIG. 7.

In this embodiment, an inclined-plane multi-turn stator winding was introduced that allows eliminating the vertical conductors 213 (FIG. 6) of the previous embodiment and simplifying the process of the stator coil winding.

A dynamoelectric machine of this embodiment contains a dual permanent-magnet rotor 100 that is similar to one of the previous embodiment and a stator containing coil 200. The rotor 100 consists of two similar axially-spaced permanent-magnet rings 104 and 105, wherein each ring consists of two axially-polarized semi-ring parts with opposite polarization. The rings 104 and 105 are turned against each other in such a way that polarization of the semi-rings are opposite, and the rings repel each other. The rotor 100 rotates around axis 103 that is aligned with axis of symmetry of the magnets. The stator consists of multi-turn elliptically-wound coil (winding) 200, which plane is inclined against the rotational plane of the rotor in such a way that the upper point of the coil 200 is positioned on a plane crossing the middle of cylindrical surface of the magnet ring 104, and the lower point of the coil 200 is positioned on a plane crossing the middle of cylindrical surface of the magnet ring 105 (as depicted in FIG. 7). Therefore, the coil 200 works as a combination of tangential and vertical members of the previous embodiment.

The prototype of this dynamoelectric machine was developed and tested. Design of the prototype of this dynamoelectric machine is depicted in FIG. 8. The test of the prototype revealed similarity of the characteristics of the dynamoelectric machine of this embodiment to ones of the dynamoelectric machine of the previous embodiment.

Multi-Phase Alternating-Current Dynamoelectric Machine with Combined Dual Permanent-Magnet Rotor and Inclined-Plane Multi-Turn Winding Stator

This dynamoelectric machine utilizes the mentioned above principle of tangential induction. The embodiment is depicted in FIG. 9.

In this embodiment, the stator comprises a number of inclined-plane multi-turn elliptically-wound coils of the previous embodiment having the same angle of the winding plane inclination, wherein long axes of the ellipse of the coils is shifted against each other on some angle, so their upper points are equally spaced on the circumference. The scheme of the machine depicted in FIG. 9 represents two-phase AC dynamoelectric machine.

The machine utilizes the stator 100 of the previous embodiment containing two similar vertically-spaced permanent-magnet rings 104 and 105, wherein each ring consists of two axially-polarized semi-ring parts with opposite polarization. The stator 200 contains two similar inclined multi-turn elliptically-wound coils (windings) 231 and 232 with the same angle of inclination. The long axes of the ellipse of the coils 231 and 232 are shifted against each other on 180 arc degrees. Therefore, the e.m.f. induced in the windings has opposite polarity. When terminals 235 and 236 are electrically connected, this connection appears as “neutral” wire, and phases of voltage on terminals 233 and 234 are shifted on 180 arc degrees so providing two-phase “star” configuration.

Basing on this embodiment, multi-phase dynamoelectric machines can be design. For three-phase configuration, the machine stator contains three similar inclined multi-turn coils with the same angle of inclination and long axes shifted on 120 arc degrees.

Statorless Alternating-Current Dynamoelectric Machine with Conductive Disk

The scheme of this embodiment of the invention is shown on FIG. 10.

A dynamoelectric machine of this embodiment contains a permanent-magnet rotor 106 with a conductive disk 212 firmly mounted on it. The rotor 100 consists of permanent ring magnet having two axially-polarized semi-ring parts 101 and 102 having opposite polarization, similar to one utilized in the embodiment depicted in FIG. 4. The conductive disk 216 is placed on the top of the magnet and has the center positioned on the rotational axis of the rotor 106. The disk 212 rotates with the magnet, wherein induced current is tapped off by brushes 217 and 218 positioned on the axis of the disk 216 and a peripheral point (edge) of the disk

The prototype of this dynamoelectric machine was tested with the 70×30×10 mm ring ferrite magnet. It develops ±2 mV AC at 1000 rpm. The deposit of brushes and outside conductors in the total e.m.f. does not exceed 0.5 mV.

Test of this dynamoelectric machine with movable brush 217 show dependence of shape, phase and amplitude of AC developed by this machine on radial position of the brush 217 (FIG. 10). When the brush 217 is placed close to axis, AC tapped off by brushes 217 and 218 has distinctive trapezoidal shape with amplitude of ±2.5 mV. The shape and phase of this AC signal are the similar to ones of the AC signal induced in not-moving radial conductor when the rotor 100 rotates (see graph U12 on FIG. 3D). When the brush 217 moves further to the disk periphery, the amplitude of the signal gradually diminishes, and the signal disappears when the brush 217 reach some point on the disk surface. Further, the signal appears again with inverted phase and sinusoidal shape, and reaches amplitude of ±2 mV on the edge of the disk.

Such behavior of the AC developed by this dynamoelectric machine shows that two mechanism of e.m.f. induction are involved simultaneously there—static Faraday's and dynamic Lorentz's ones. On some radial distance from the disk axis, the motional (Lorentz's) e.m.f. developed in the disk compensates the static Faraday's e.m.f. developed in the stationary conductors connecting the brushes 217 and 218 with a load (FIG. 10), and the motional e.m.f. dominates in the total e.m.f. developed this machine when the brush 217 is on the edge of the disk 216.

This mechanism of e.m.f. induction (when the brush 217 is positioned on the edge of the disk 212) is the same that develops e.m.f. in homopolar generator (FIG. 1). Thus, the dynamoelectric machine of this embodiment is Alternating-Current Statorless Homopolar Generator.

### THE DRAWINGS

FIG. 1 depicts a statorless homoploar generator scheme.

FIG. 2 depicts homopolar and multi-polar rotor schemes with the pole positions.

FIG. 3 depicts a scheme of tangential induction experiments.

FIG. 4 depicts the preferable embodiment of the invention—a tangential-induction alternating-current dynamoelectric machine having combined permanent-magnet rotor and multi-turn stator winding.

FIG. 5 depicts the design of prototype of the preferable embodiment of the invention.

FIG. 6 depicts another embodiment of the invention—a tangential-induction alternating-current dynamoelectric machine with a dual combined permanent-magnet rotor and a multi-turn stator having two-stage winding.

FIG. 7 depicts another embodiment of the invention—a tangential-induction alternating-current dynamoelectric machine with the dual combined permanent-magnet rotor and stator containing multi-turn inclined-plane winding.

FIG. 8 depicts the design of prototype of the embodiment of the invention—a tangential-induction alternating-current dynamoelectric machine with the dual combined permanent-magnet rotor and stator containing multi-turn inclined-plane winding.

FIG. 9 depicts another embodiment of the invention—two phase tangential-induction alternating-current dynamoelectric machine with the dual combined permanent-magnet rotor and stator containing two multi-turn inclined-plane windings.

FIG. 10 depicts another embodiment of the invention—the statorless alternating-current dynamoelectric machine having the combined permanent-magnet rotor with a conductive disk firmly fastened on it.

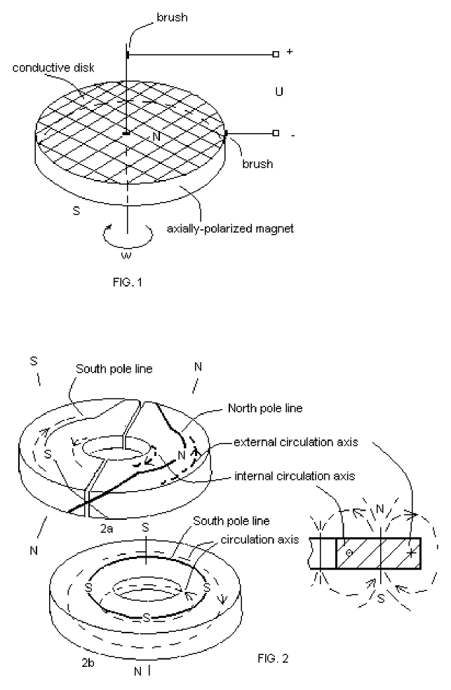

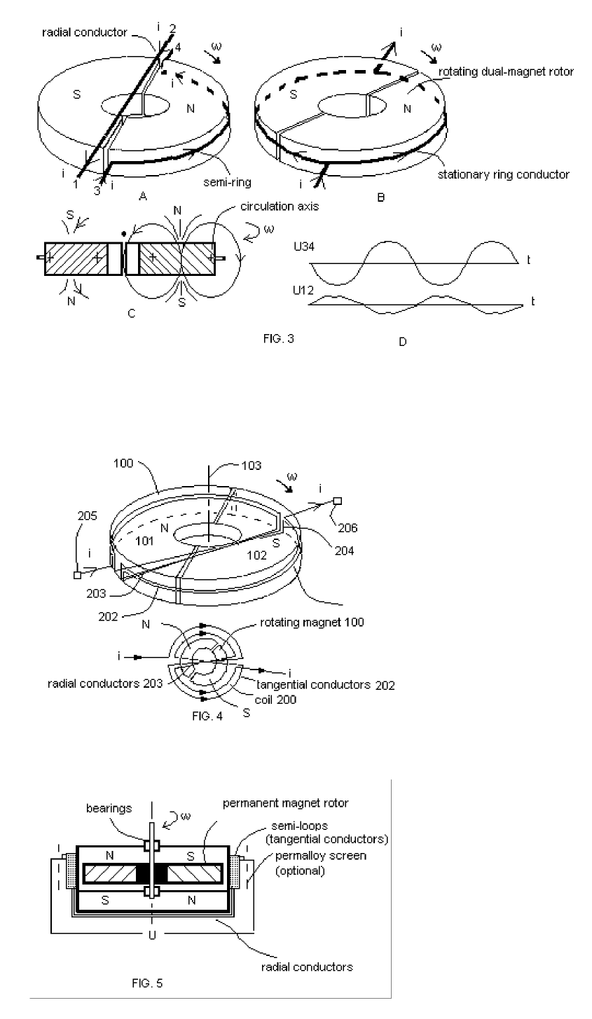

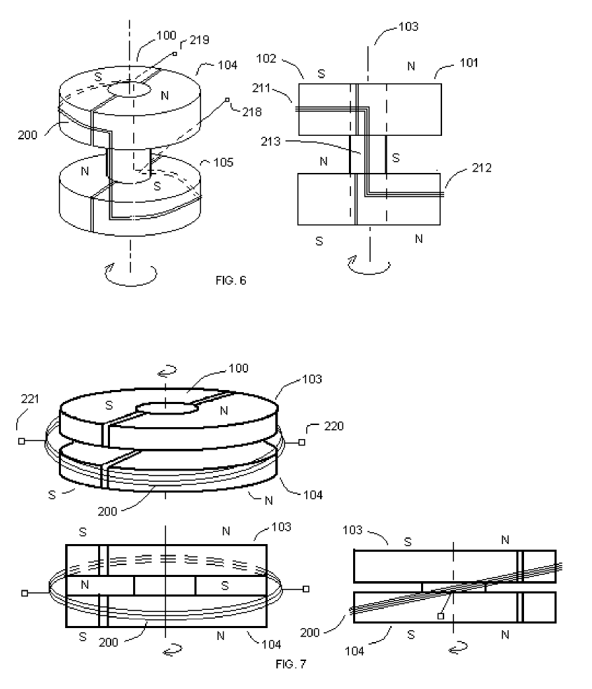

What is claimed is:

1. An alternating-current dynamoelectric machine comprising:
A permanent-magnet rotor;
A stator with winding containing one or more electric conductors;
wherein the improvements that allow developing tangential induction comprises:
A cylindrical rotor containing an axially-polarized permanent-magnet ring mounted on said rotor in such a way that axis of said magnet ring and rotational axis of said rotor are aligned, wherein said magnet ring consists of two similar, but oppositely polarized sections;
a stator containing a stationary semi-ring conductor, wherein said semi-ring is placed on plane crossing the middle of cylindrical surface of the said magnet ring and geometrical center of said semi-ring is matched with rotational axis of said rotor, and induced current is tapped off by terminals connected to end points of said semi-ring.

2. The alternating-current dynamoelectric machine of claim 1, wherein said stator contains a stationary close-loop conductive ring having geometrical center matched with rotational axis of said rotor, wherein induced current is tapped off by terminals connected to diametrical opposite points of said ring.

3. The alternating-current dynamoelectric machine of claim 1, wherein said stator comprises a stationary multi-turn winding containing a number of the semi-ring conductors of claim 1 and radial conductors connecting opposite ends of said semi-rings in such a way that e.m.f. induced in said semi-rings add together, wherein induced current is tapped off by terminals connected to ends of said winding as depicted in FIG. 4.

4. An alternating-current dynamoelectric machine comprising:
A dual permanent-magnet rotor containing two firmly mounted on the same axis axially-polarized permanent-magnet rings of claim 1, wherein said magnet rings are axially spaced and turned in such a way that the same poles of adjacent sections of said magnet rings are positioned against each other as depicted in FIG. 6;
a stator comprising a stationary two-stage multi-turn winding that consists of a number of semi-ring conductors of claim 1 and vertical conductors, which are positioned on said stator in such a way that half of said semi-ring conductors is placed on plane crossing the middle of cylindrical surface of the upper said magnet ring and another half of said semi-ring conductors is placed on plane crossing the middle of cylindrical surface of the lower said magnet ring as depicted in FIG. 6, wherein said vertical conductors connect opposite ends of said upper and lower semi-rings in such a way that e.m.f. induced in said semi-rings add together, and induced current is tapped off by terminals connected to ends of said winding.

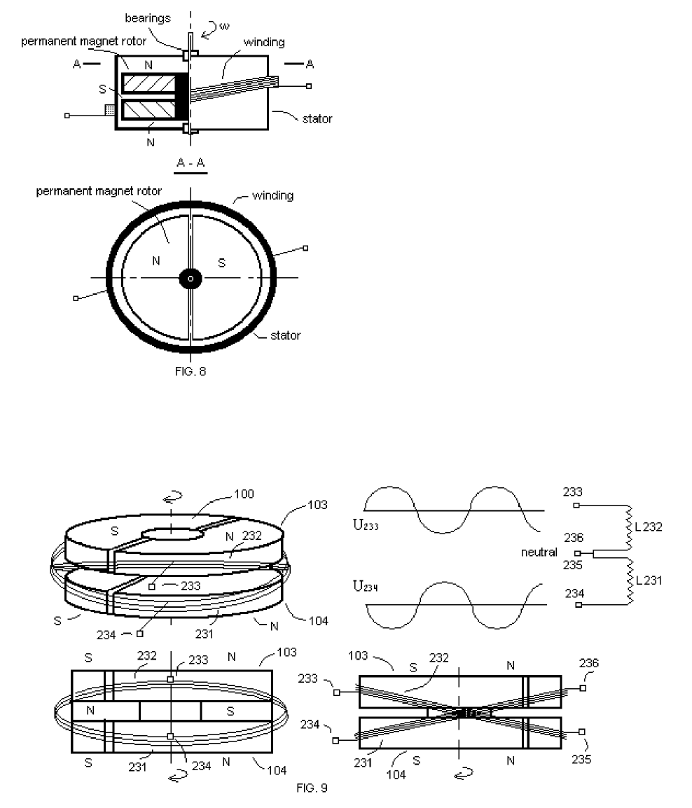

5. An alternating-current dynamoelectric machine comprising:
The dual permanent-magnet rotor of claim 4;
A stator comprising a stationary multi-turn elliptically-wound coil, wherein winding plane of said coil is inclined against the rotational plane of said rotor in such a way that the upper point of said coil is positioned on the plane crossing the middle of cylindrical surface of the upper magnet ring of claim 4, and the lower point of said coil is positioned on the plane crossing the middle of cylindrical surface of the lower magnet ring of claim 4 as depicted in FIG. 7; therefore, said coil substitutes tangential and vertical conductors of the stator winding of the dynamoelectric machine of claim 4, and induced current is tapped off by terminals connected to ends of said coil.

6. A multi-phase alternating-current dynamoelectric machine comprising:
The dual permanent-magnet rotor of claim 5;
A stator comprising a number of stationary multi-turn elliptically-wound coils of claim 5, wherein a number of phases of said dynamoelectric machine is equal to the number of said coils, and, to achieve the phase shift, each said coil is turned against each other in such a way that long axes of said elliptical coils are equally spaced on a circumference; therefore, for three-phase alternating-current dynamoelectric machine of this claim, said long axes are spaced on 120 arc degrees, and said coils are connected in tree or star configuration.

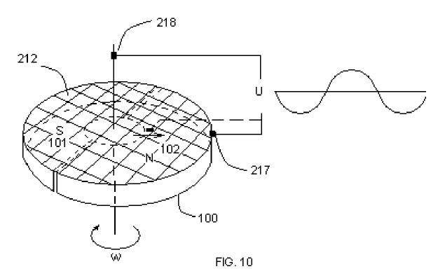

7. An alternating-current statorless dynamoelectric machine comprising the rotor of claim 1 and a conductive disk, wherein said conductive disk having the geometric center matched with rotational axis of said rotor is firmly placed on said rotor as depicted in FIG. 10, and rotates together with said rotor; wherein induced current is tapped off by a brush positioned on the axis of said disk and a brush positioned on edge of said disk.
